(19) United States
(12) Patent Application Publication
(10) Pub. No.: US 2013/0177185 A1
(43) Pub. Date: Jul. 11, 2013

(54) INFORMATION PROCESSING APPARATUS AND SPEAKER

(71) Applicant: Sony Corporation, Tokyo (JP)

(72) Inventors: Kazuaki Takahashi, Nagano (JP); Shuhei Yukawa, Nagano (JP); Yuki Atsumi, Nagano (JP)

(73) Assignee: SONY CORPORATION, Tokyo (JP)

(21) Appl. No.: 13/722,297

(22) Filed: Dec. 20, 2012

(30) Foreign Application Priority Data
Jan. 4, 2012 (JP) 2012-000120

(51) Int. Cl. H04R 5/02

(52) U.S. Cl. CPC H04R 5/02
USPC 381/300

(57) ABSTRACT

There is provided an information processing apparatus including a speaker having speaker units of a speaker for a left channel that outputs left channel audio, a speaker for a right channel that outputs right channel audio, and a speaker for bass that outputs bass, wherein the speaker units are integrally formed with one another and the speaker is provided in a housing.

### CROSS-REFERENCE TO RELATED APPLICATION

The present application claims priority from Japanese Patent Application No. JP 2012-000120 filed in the Japanese Patent Office on Jan. 4, 2012, the entire content of which is incorporated herein by reference.

### BACKGROUND

The present technology relates to an information processing apparatus configured to perform information processing and a speaker configured to emit audio.

In recent years, an integral type (all-in-one) personal computer provided in advance with application software, peripheral devices and the like, which have high usage frequency, has been spread.

Such a personal computer has a configuration in which an image display panel and peripheral devices including a speaker are assembled in a housing constituted by superposing a front cabinet and a back cabinet with each other.

The speaker typically has a speaker for a left channel that outputs left channel audio and a speaker for a right channel that outputs right channel audio. Moreover, the speaker has a speaker called a woofer that outputs bass audio.

There has been proposed technology of the related art for performing surround reproduction through a speaker integrally provided to a television receiver (see, for example, JP 2004-247890A).

### SUMMARY

As described above, the speaker is provided with three speaker units for the left channel, the right channel, and the woofer. In the related art, these speaker units are constituted as individual speaker units separated from one another.

Therefore, in the case of assembling (for example, mounting or exchanging) the speaker units to the housing, since it is necessary to assemble the speaker for a left channel, the speaker for a right channel, and the woofer to the speaker units, it is difficult to easily perform the assembling process.

As described above, since the speaker of the related art has a structure in which the three speaker units for the left channel, the right channel, and the woofer are constituted as individual units separated from one another, there is a problem that assembling efficiency is low.

In light of the foregoing, it is desirable to provide an information processing apparatus having a speaker with high assembling efficiency.

Furthermore, in light of the foregoing, it is desirable to provide a speaker with high assembling efficiency.

In order to solve the problems, an information processing apparatus is provided. The information processing apparatus includes a speaker having speaker units of a speaker for a left channel that outputs left channel audio, a speaker for a right channel that outputs right channel audio, and a speaker for bass that outputs bass, wherein the speaker units are integrally formed with one another and the speaker is provided in a housing.

Furthermore, a speaker is provided. The speaker includes a speaker for a left channel that outputs left channel audio, a speaker for a right channel that outputs right channel audio, and a woofer for bass that outputs bass, and speaker units thereof are integrally formed with one another.

It is possible to improve assembling efficiency.

### BRIEF DESCRIPTION OF THE DRAWINGS

FIG. 1 is a diagram illustrating a configuration example of an information processing apparatus;

FIG. 2 is a diagram illustrating a configuration example of a speaker;

FIG. 3 is a diagram illustrating a configuration example of a speaker;

FIG. 4 is a diagram illustrating a configuration example of a speaker;

FIG. 5 is a diagram illustrating a configuration example of a speaker;

FIG. 6 is a diagram illustrating a mounting state of a speaker;

FIG. 7 is a diagram illustrating a general appearance of an information processing apparatus on which a speaker is mounted;

FIG. 8 is a diagram illustrating a general appearance of an information processing apparatus on which a speaker is mounted;

FIG. 9 is a diagram illustrating a general appearance of an information processing apparatus on which a speaker is mounted;

FIG. 10 is a diagram illustrating a general appearance of an information processing apparatus on which a speaker is mounted;

FIG. 11 is a diagram for describing speaker capacity;

FIGS. 12A and 12B are diagrams illustrating a bass reflex port in a speaker;

FIGS. 13A and 13B are diagrams illustrating a bass reflex port in a speaker;

FIGS. 14A and 14B are diagrams illustrating a bass reflex port in a speaker;

FIGS. 15A and 15B are diagrams illustrating a bass reflex port in a speaker;

FIG. 16 is a diagram illustrating an intake structure of a speaker;

FIG. 17 is a diagram illustrating intake air flow;

FIG. 18 is a diagram illustrating a sealing structure of a speaker; and

FIG. 19 is a diagram illustrating a sealing structure of a speaker.

### DETAILED DESCRIPTION OF THE EMBODIMENT(S)

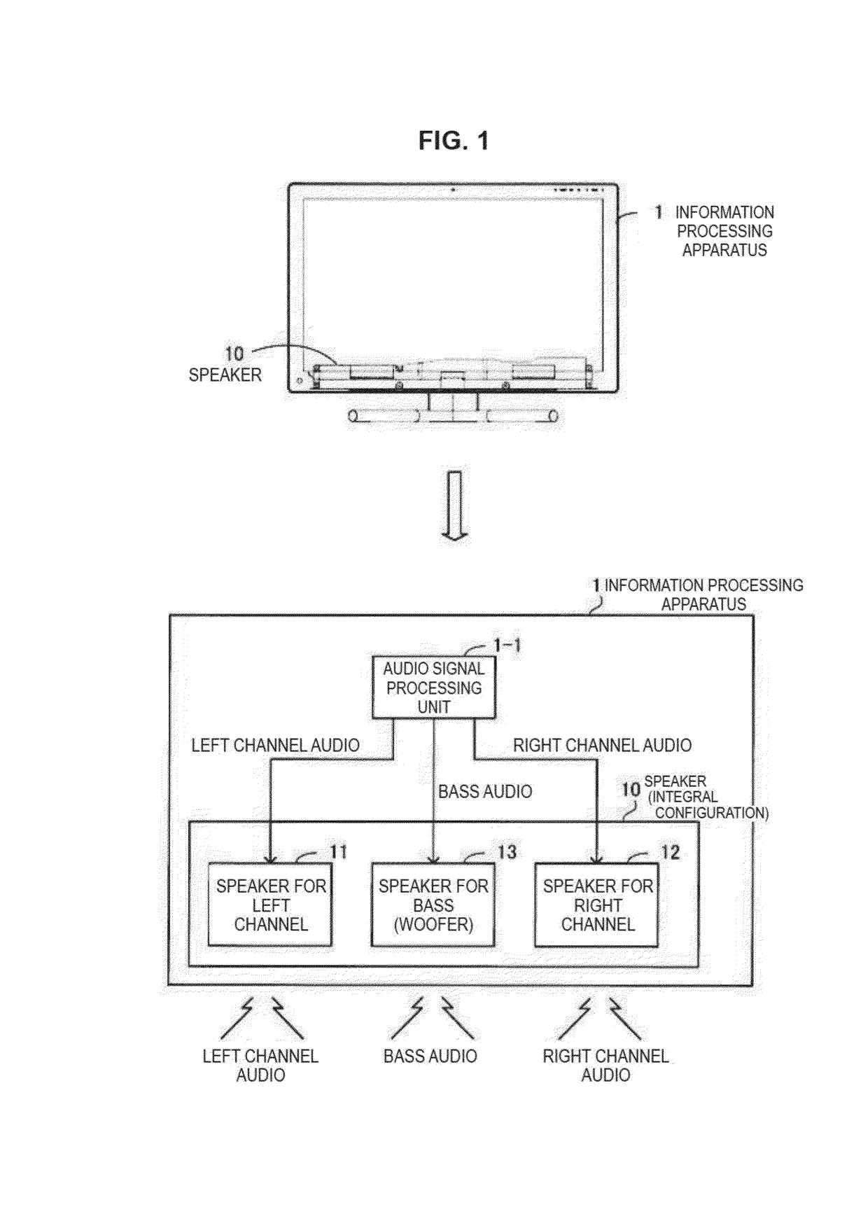

Hereinafter, an embodiment will be described with reference to the accompanying drawings. FIG. 1 is a diagram illustrating a configuration example of an information processing apparatus. An information processing apparatus 1 includes an audio signal processing unit 1-1 and a speaker 10. The speaker 10 includes a speaker 11 for a left channel, a speaker 12 for a right channel, and a woofer 13 for bass (hereinafter referred to as a woofer).

The audio signal processing unit 1-1 performs audio signal processing and outputs left channel audio, right channel audio, and bass audio.

The speaker 11 for a left channel outputs (emits) the left channel audio to an exterior. The speaker 12 for a right channel outputs the right channel audio to an exterior. The woofer 13 outputs the bass audio to an exterior.

Furthermore, in the speaker 10, the speaker 11 for a left channel, the speaker 12 for a right channel, and the woofer 13 are not speaker units individually separated from one another, and these three speaker units are integrally formed with one another. The integral type speaker 10 is mounted in a housing of the information processing apparatus 1.

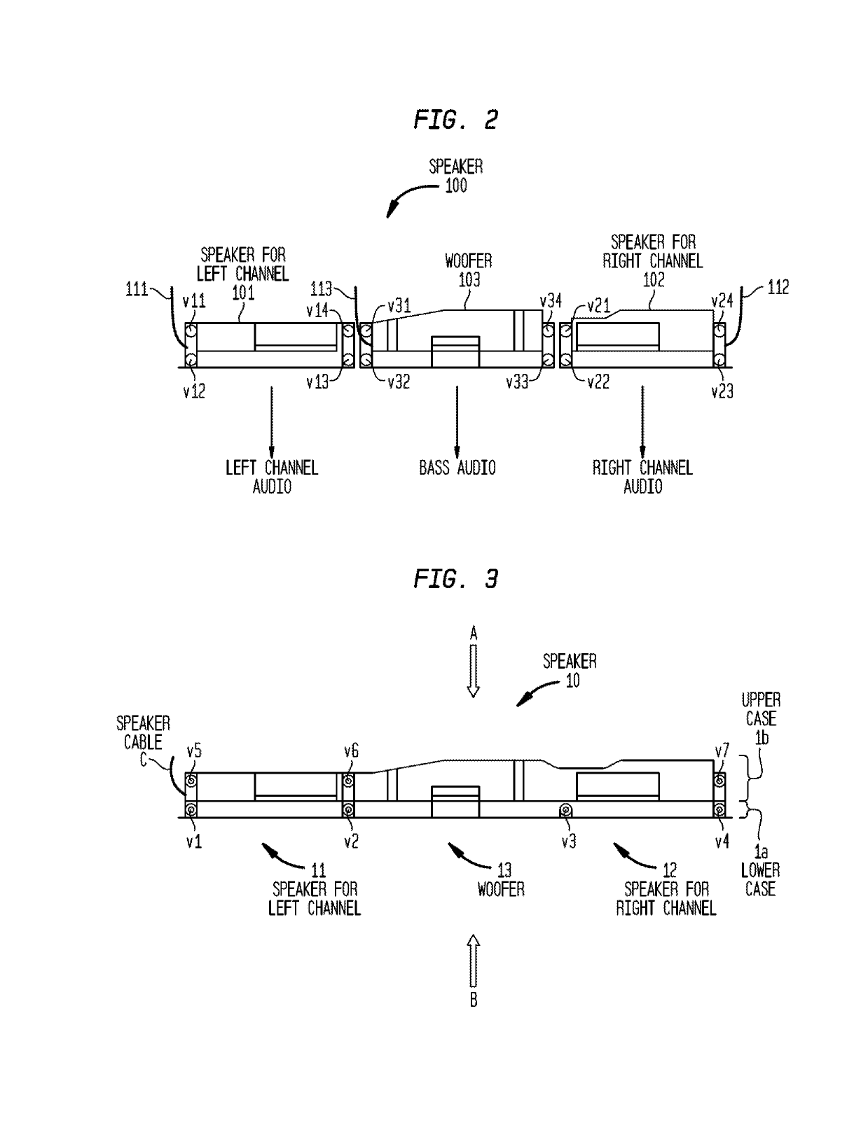

Next, before describing the speaker 10, the configuration of a general speaker will be described. FIG. 2 is a diagram illustrating a configuration example of a speaker. FIG. 2 illustrates the configuration when a speaker 100 of the related art is viewed from the front.

The speaker 100 includes three speaker units of a speaker 101 for a left channel, a speaker 102 for a right channel, and a woofer 103, wherein the speaker units are constituted as individual units separated from one another.

In addition, left channel audio from the speaker 101 for a left channel is output downward. Similarly, right channel audio from the speaker 102 for a right channel is output downward, and bass audio from the woofer 103 is output downward.

Furthermore, the speaker 101 for a left channel is provided with four screws v11 to v14 for screwing and fixing the speaker 101 to the housing.

Moreover, the speaker 102 for a right channel is provided with four screws v21 to v24 for screwing and fixing the speaker 102 to the housing.

Moreover, the woofer 103 is provided with four screws v31 to v34 for screwing and fixing the woofer 103 to the housing.

Meanwhile, the speaker 101 for a left channel is provided with a speaker cable 111 through which the left channel audio is input, and the speaker 102 for a right channel is provided with a speaker cable 112 through which the right channel audio is input. Moreover, the woofer 103 is provided with a speaker cable 113 through which the bass audio is input.

As described above, since the speaker 100 of the related art has a structure in which the three speaker units are constituted as individual units separated from one another, there is a problem that assembling efficiency is low. Furthermore, as well as the problem of the assembling efficiency, there are problems in terms of manufacturability, audio quality and the like (which will be described later).

In light of the foregoing, the present technology provides the information processing apparatus 1 having the speaker 10 in which the aforementioned problems are solved. Furthermore, the present technology provides the speaker 10 in which the aforementioned problems are solved.

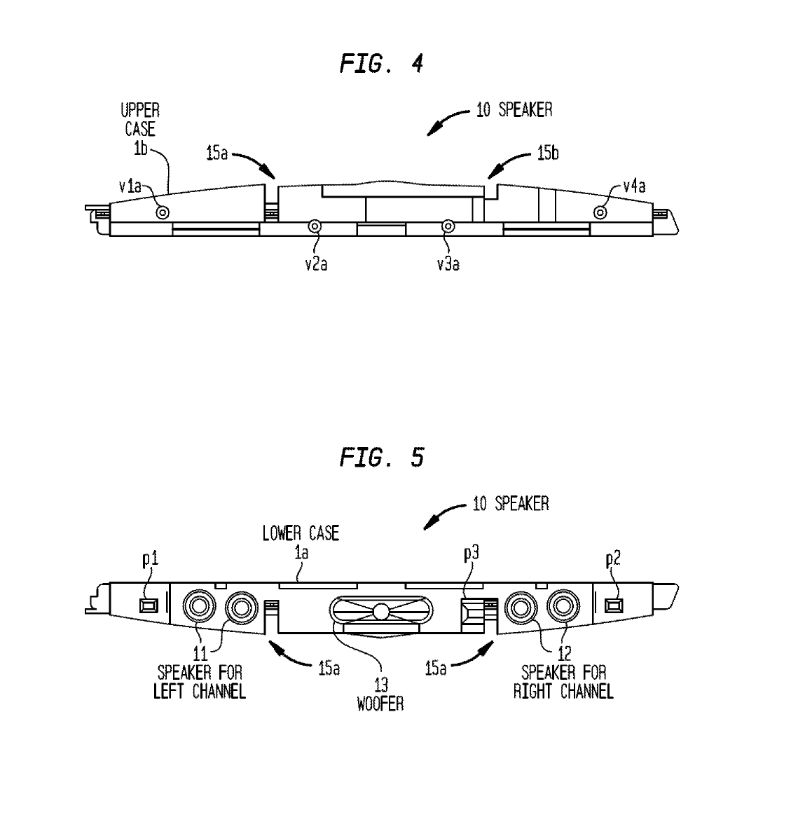

Next, the configuration of the speaker 10 of the present technology will be described in detail. FIG. 3 to FIG. 5 are diagrams illustrating a configuration example of the speaker. FIG. 3 is a diagram illustrating the front of the speaker 10. FIG. 4 is a diagram when FIG. 3 is viewed from a direction A (an upper direction of the speaker). FIG. 5 is a diagram when FIG. 3 is viewed from a direction B (a lower direction of the speaker).

The speaker 10 is provided with a lower case 1a and an upper case 1b. The lower case 1a is provided with the three speaker units of the speaker 11 for a left channel, the speaker 12 for a right channel, and the woofer 13, wherein the three speaker units are integrally formed with one another.

The speaker 10 is provided with seven screws v1 to v7 for screwing and fixing the speaker 10 to the housing. Moreover, the speaker 10 is provided with screws v1a to v4a for connecting the lower case 1a to the upper case 1b. The lower case 1a and the upper case 1b are firmly fixed to each other by the screws v1a to v4a and ultrasonic welding.

Furthermore, the lower case 1a of the speaker 10 is formed with intake holes 15a and 15b for cooling the interior of the information processing apparatus 1. Moreover, the speaker 11 for a left channel is formed with a hole p1 of a bass reflex port for left channel audio.

Similarly, the speaker 12 for a right channel is formed with a hole p2 of a bass reflex port for right channel audio, and the woofer 13 is formed with a hole p3 of a bass reflex port for bass audio. The intake holes and the bass reflex port will be described later.

Moreover, the speaker 10 is provided with a speaker cable C. The speaker cable C is obtained by bundling a speaker cable installed in the speaker 11 for a left channel, a speaker cable installed in the speaker 12 for a right channel, and a speaker cable installed in the woofer 13 into one.

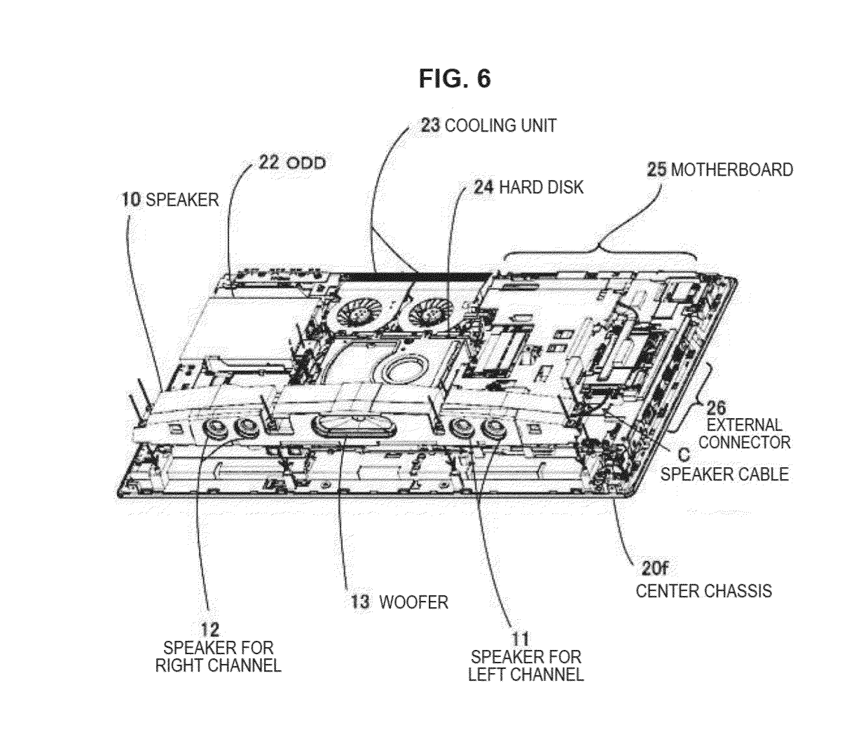

FIG. 6 is a diagram illustrating a mounting state of the speaker. FIG. 6 illustrates an internal structure when the information processing apparatus 1 is viewed from a back surface of a screen thereof, and illustrates a state in which the speaker 10 is mounted in a center chassis 20f in the housing of the information processing apparatus 1.

The center chassis 20f has mounted thereon an ODD (Optical Disc Drive) 22, into which a Blu-ray Disc, a CD (Compact Disc) and the like are inserted, a cooling unit 23 serving as a cooling fan, a hard disk 24, a motherboard 25 and the like.

Furthermore, the motherboard 25 has mounted thereon an external connector 26 for being connected to a USB (Universal Serial Bus) cable and the like. The speaker 10 is mounted in a lower portion of the center chassis 20f from the back surface of the information processing apparatus 1 toward an arrow direction illustrated in FIG. 6.

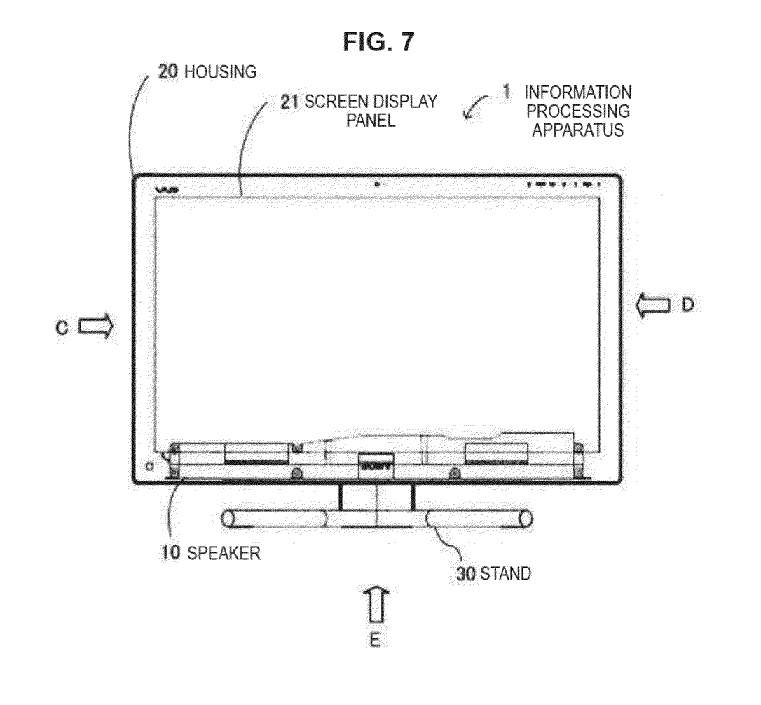

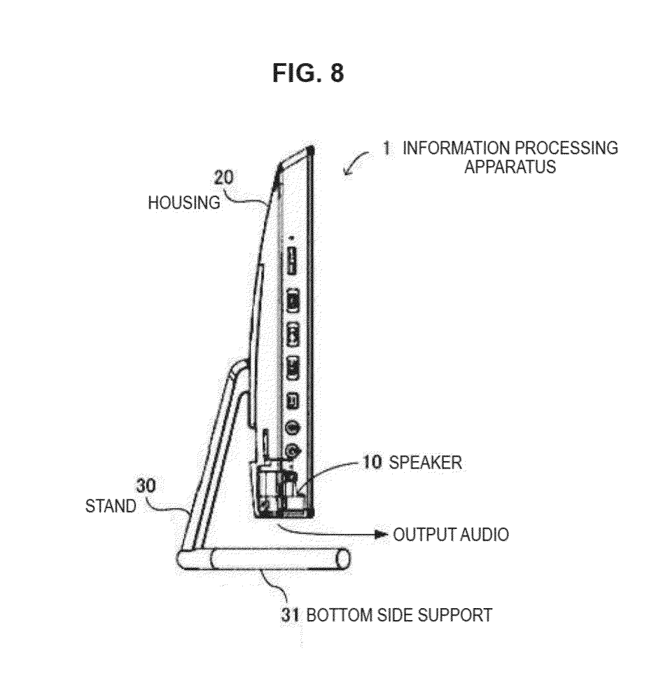

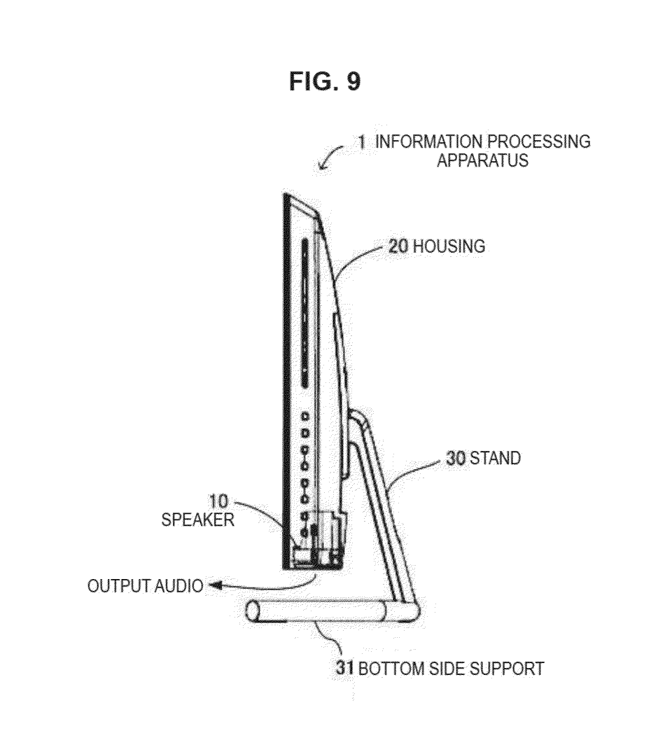

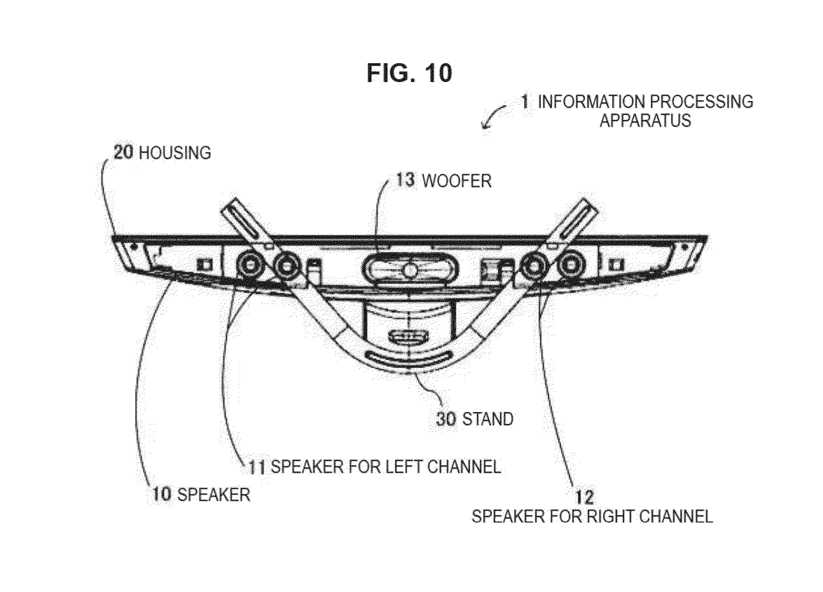

FIG. 7 to FIG. 10 are diagrams illustrating a general appearance of the information processing apparatus on which the speaker is mounted. FIG. 7 is a front view of the information processing apparatus 1 (a diagram when the information processing apparatus 1 is viewed from the front surface of a screen). FIG. 8 is a side view when FIG. 7 is viewed from a direction C, and FIG. 9 is a side view when FIG. 7 is viewed from a direction D. FIG. 10 is a diagram when FIG. 7 is viewed from a direction E (a diagram when the information processing apparatus is viewed from the lower side thereof).

In the information processing apparatus 1, for example, an L-shaped stand 30 is mounted on the back surface of a housing 20 including an image display panel 21. A bottom side support 31 of the stand 30 is placed on a table, so that a space is formed between the bottom side support 31 of the stand 30 and the housing 20.

The speaker 10 is mounted in a lower portion of the housing 20 to output audio from the space formed between the bottom side support 31 of the stand 30 and the housing 20.

Thus, the left channel audio from the speaker 11 for a left channel is output from a lower direction of the housing 20 to an exterior. Similarly, the right channel audio from the speaker 12 for a right channel is output from the lower direction of the housing 20 to an exterior, and the bass audio from the woofer 13 is output from the lower direction of the housing 20 to an exterior.

As described above, the speaker 10 has a structure in which the speaker 11 for a left channel, the speaker 12 for a right channel, and the woofer 13 are integrally formed with one another without being separated from one another in units of speaker units. Consequently, as compared with the related art, an assembly procedure is significantly reduced, and the speaker 10 is easily assembled to the housing 20, so that the assembling efficiency is remarkably improved.

Furthermore, in the speaker 10, the speaker 11 for a left channel, the speaker 12 for a right channel, and the woofer 13 are integrally formed with one another, so that they can be simultaneously mounted in the housing, resulting in the improvement of workability.

Meanwhile, in the configuration of the speaker 100 of the related art, since speaker cables are provided to individual speaker units, it is difficult to easily arrange (route) the wiring of the speaker cables in the housing.

On the other hand, the speaker 10 has an integral structure, so that it is possible to bundle the speaker cable for a left channel, the speaker cable for a right channel, and the speaker cable of the woofer 13 into one. In this way, the outlets of the speaker cables are integrally formed with one another, so that it is possible to simplify the arrangement of the wiring in the housing 20.

Moreover, in the speaker 100 of the related art, it is necessary to provide the speaker units with screwing screws for being mounted in the housing. However, in the integral type speaker 10, it is possible to reduce the number of screwing screws for being mounted in the housing 20, resulting in the improvement of the manufacturability of the speaker itself.

Moreover, in the speaker 100 of the related art, since the number of manufacturing parts is large, it is difficult to increase speaker capacity in a limited space in the housing. On the other hand, in the speaker 10, it is also possible to increase speaker capacity as compared with the speaker 100 of the related art.

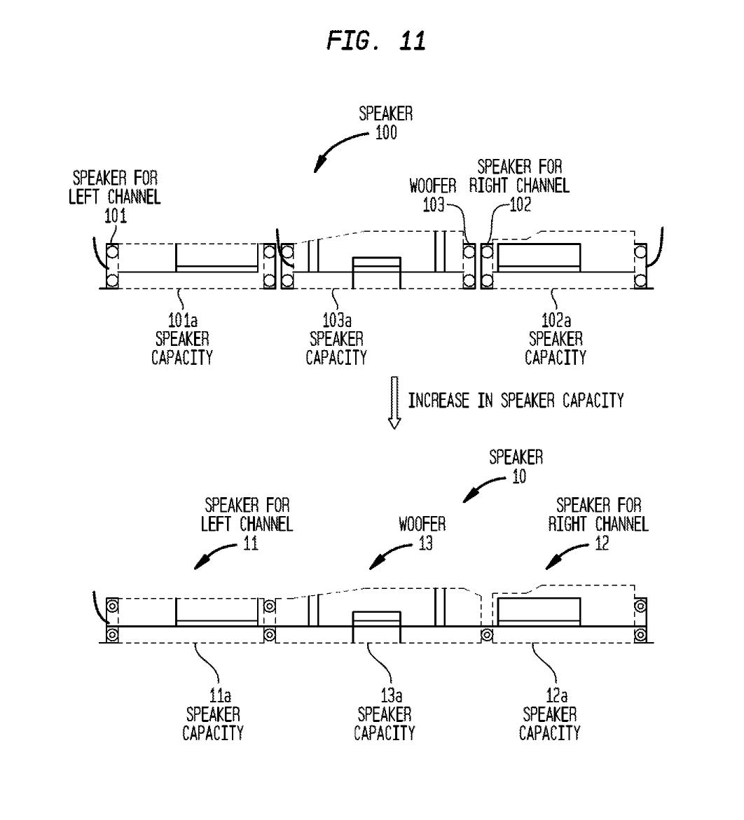

FIG. 11 is a diagram for describing speaker capacity. FIG. 11 illustrates the difference between the speaker capacity of the speaker 100 of the related art and the speaker capacity of the speaker 10 of the present technology. Furthermore, FIG. 11 illustrates the speaker capacity using dotted frames.

In the speaker 100, the speaker 101 for a left channel has speaker capacity 101a, the speaker 102 for a right channel has speaker capacity 102a, and the woofer 103 has speaker capacity 103a.

Meanwhile, in the speaker 10, the speaker 11 for a left channel has speaker capacity 11a, the speaker 12 for a right channel has speaker capacity 12a, and the woofer 13 has speaker capacity 13a.

Here, the sum of the speaker capacities 11a, 12a, and 13a of the speaker 10 is larger than the sum of the speaker capacities 101a, 102a, and 103a of the speaker 100. That is, the speaker units are integrally formed with one another, resulting in an increase in the speaker capacity.

This is because the speaker 100 is configured by individual speaker units, fixing structures (screw-providing parts and the like) for being mounted in the housing are provided to the respective speaker units, and thus the speaker capacity is reduced corresponding to the fixing structures.

On the other hand, since the speaker 10 has an integral structure, it is possible to reduce the number of the fixing structures for being mounted in the housing 20 as compared with the speaker of the related art, so that the speaker capacity is increased by the reduced amount.

In this way, since the speaker 10 has an integral structure, it is possible to reduce the number of manufacturing parts, and to increase the speaker capacity in a limited space in the housing 20 as compared with the speaker of the related art configured by individual units.

Next, the bass reflex port formed in the speaker 10 will be described. In addition, the bass reflex port is an audio path provided in a speaker box to allow audio to pass therethrough.

In general, a speaker outputs opposite phase audios through the front and back surfaces thereof. Therefore, it is necessary to prevent the audio from the front surface from being mixed with the audio from the back surface in the speaker box.

In this regard, the speaker box is provided with a bass reflex port as a path of the audio output from the back surface of the speaker. The bass reflex port having an appropriate length is provided to allow the audio from the back surface to pass therethrough, so that the phase of the audio from the back surface is inverted.

Then, after the phase inversion in the speaker box, the audio is output to an exterior, so that it is possible to use the audio output from the back surface of the speaker. In addition, it is possible for the speaker box to contribute to the improvement of bass.

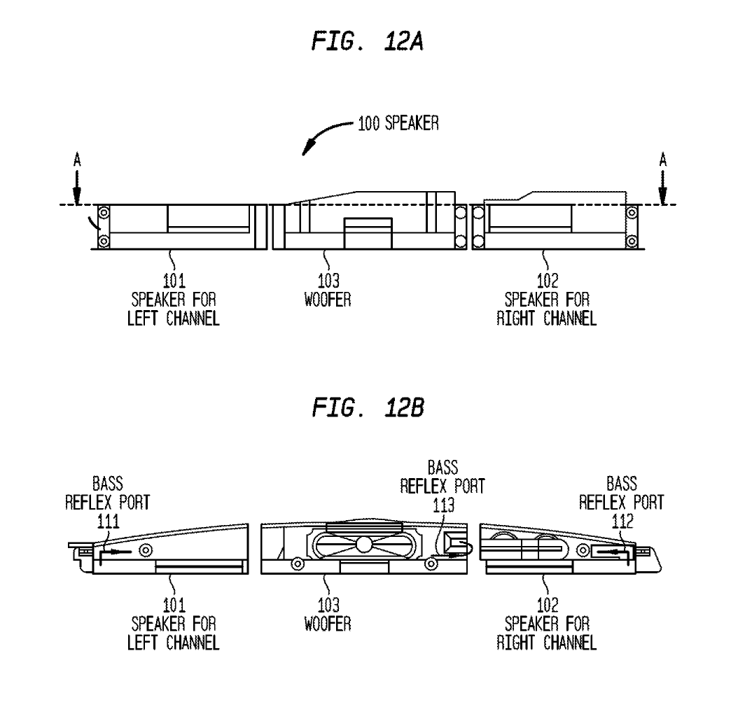

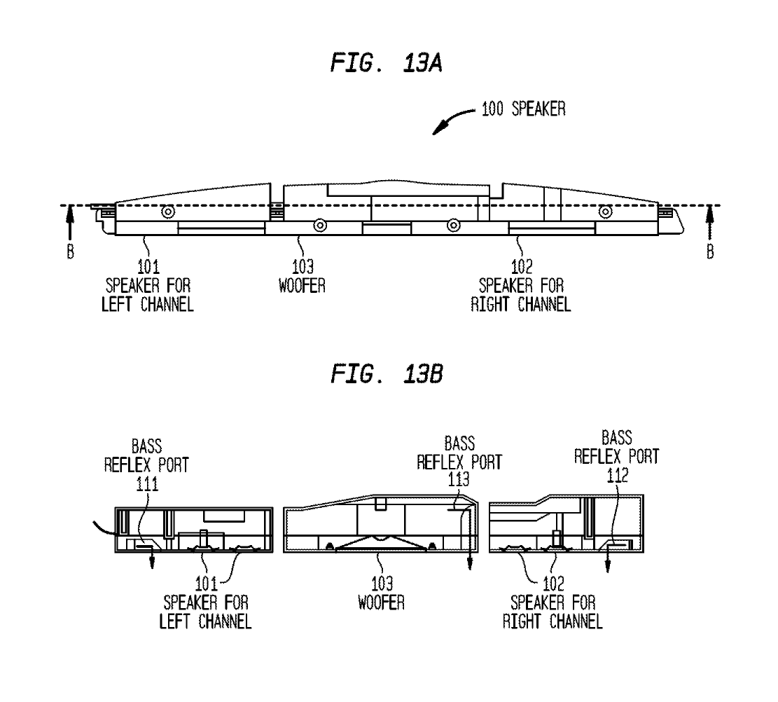

FIGS. 12A, 12B, 13A and 13B are diagrams illustrating the bass reflex ports in a speaker. FIGS. 12A, 12B, 13A and 13B illustrate arrangement states of the bass reflex ports in the speaker 100 of the related art. FIG. 12A is a front view of the speaker 100 and FIG. 12B illustrates the bass reflex ports in a sectional view taken along line A-A of FIG. 12A.

Furthermore, FIG. 13A is a view when the speaker 100 is viewed from an upper direction and FIG. 13B illustrates the bass reflex ports in a sectional view taken along line B-B of FIG. 13A.

In addition, in FIGS. 12A, 12B, 13A and 13B, the directions of arrows indicating the bass reflex ports indicate the flow of air, the rear ends of the arrows are directed to the back surface of the speaker, and the front ends of the arrows are directed to bass reflex port holes through which audio is output.

In the speaker 100, since the speaker 101 for a left channel, the speaker 102 for a right channel, and the woofer 103 are constituted as individual units separated from one another, the bass reflex port is provided to each speaker unit.

That is, a bass reflex port 111 is provided in the speaker 101 for a left channel, a bass reflex port 112 is provided in the speaker 102 for a right channel, and a bass reflex port 113 is provided in the woofer 103.

In this way, in the speaker 100, since the bass reflex ports are individually formed in the speaker units, there are cases in which it is difficult to sufficiently ensure the lengths of the bass reflex ports, so that it is difficult to appropriately form the bass reflex ports.

Here, particularly, when emphasizing a frequency of bass, it is necessary to ensure bass reflex ports having a certain length. However, as with the speaker 100, when the bass reflex ports are individually formed in the speaker units, there are cases in which it is difficult to ensure bass reflex ports having a sufficient length.

That is, in the arrangement of the bass reflex port in each speaker unit, there are cases in which a length is not sufficient to emphasize the frequency of bass. Therefore, the quality of bass audio may be degraded.

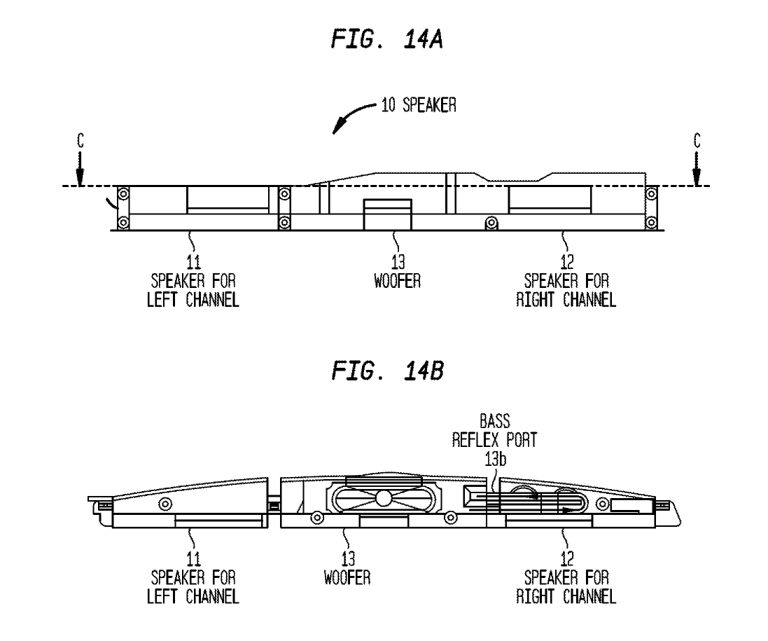

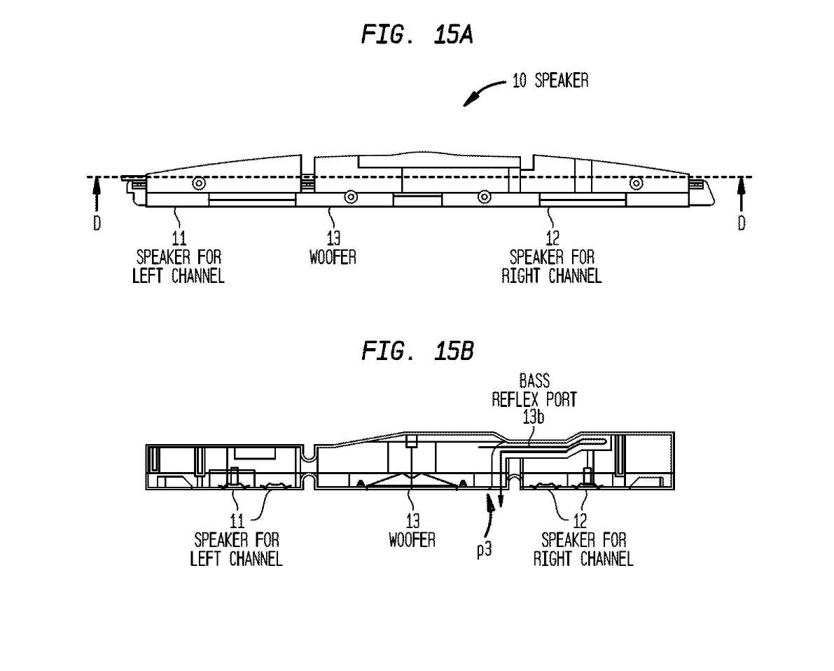

FIGS. 14A, 14B, 15A and 15B are diagrams illustrating the bass reflex port in a speaker. FIGS. 14A, 14B, 15A and 15B illustrate arrangement states of the bass reflex port in the speaker 10 of the present technology. In addition, FIGS. 14A, 14B, 15A and 15B illustrate only the bass reflex port of the woofer 13.

FIG. 14A is a front view of the speaker 10 and FIG. 14B illustrates the bass reflex port in a sectional view taken along line C-C of FIG. 14A.

Furthermore, FIG. 15A is a view when the speaker 10 is viewed from an upper direction and FIG. 15B illustrates the bass reflex port in a sectional view taken along line D-D of FIG. 15A.

In addition, in FIGS. 14A, 14B, 15A and 15B, the directions of arrows indicating the bass reflex ports indicate the flow of air, the rear ends of the arrows are directed to the back surface of the speaker, and the front ends of the arrows are directed to a bass reflex port hole p3 through which audio is output.

In the speaker 10, since the speaker 101 for a left channel, the speaker 102 for a right channel, and the woofer 103 are integrally formed with one another, it is possible to arrange the bass reflex port by expanding the bass reflex port to the side of adjacent speaker units.

For example, in FIGS. 14A, 14B, 15A and 15B, a bass reflex port 13b for the woofer 13 is provided. However, the bass reflex port 13b is expanded over the speaker unit area of the speaker 12 for a right channel.

In this way, since the speaker 10 has an integral structure, it is possible to arbitrarily extend the length of the bass reflex port to the areas of adjacent speaker units according to necessity. Consequently, it is possible to perform optimal audio design by flexibly ensuring the bass reflex port having a sufficient length to emphasize the frequency of bass, resulting in the improvement of the quality of the bass audio.

In addition, in the above, the example in which the bass reflex port 13b of the woofer 13 is expanded to the speaker 12 for a right channel has been described. However, the bass reflex port 13b of the woofer 13 may also be expanded to the speaker 11 for a left channel. Furthermore, only the bass reflex port 13b of the woofer 13 has been described. However, bass reflex ports of the speaker 11 for a left channel and the speaker 12 for a right channel are the same as in the case of the bass reflex port 13b of the woofer 13.

That is, in relation to the speaker 11 for a left channel, the bass reflex port of the speaker 11 for a left channel may be expanded to the area of the speaker unit of the woofer 13 according to necessity.

Similarly, in relation to the speaker 12 for a right channel, the bass reflex port of the speaker 12 for a right channel may be expanded to the area of the speaker unit of the woofer 13 according to necessity.

Next, an intake structure provided in the speaker 10 will be described. The speaker 10 has a high capacity speaker structure as described above.

When the speaker 10 with the high capacity speaker structure is mounted in the information processing apparatus 1 as is, an intake hole of the information processing apparatus 1 is likely to be closed. In this regard, the speaker 10 of the present technology has an intake structure, so that the interior of the information processing apparatus 1 is cooled through the intake structure.

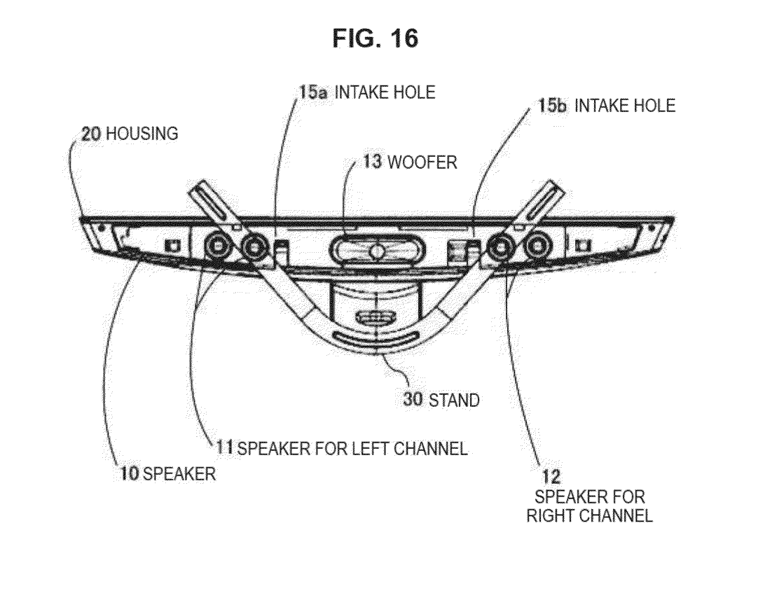

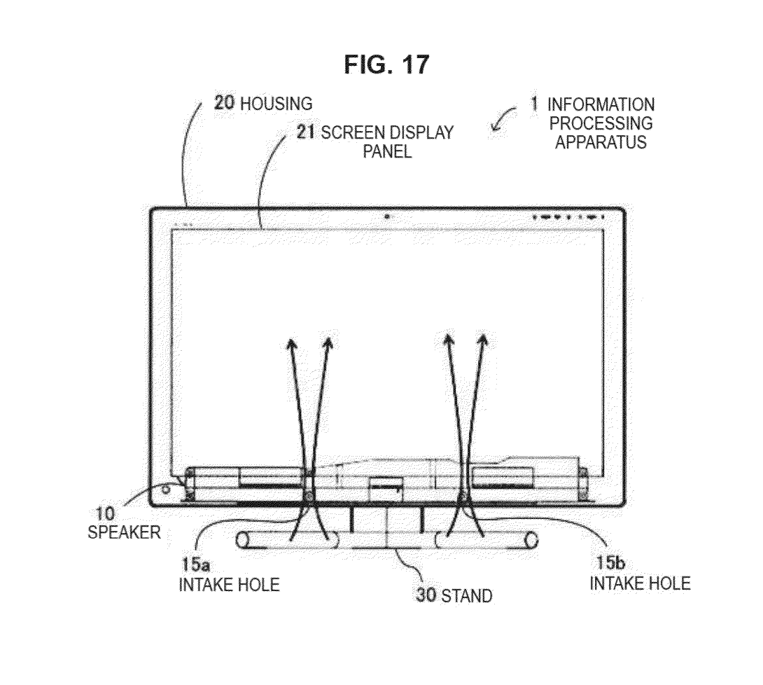

FIG. 16 is a diagram illustrating the intake structure of the speaker and FIG. 17 is a diagram illustrating intake air flow. The speaker 10, for example, is formed with intake holes 15a and 15b on left and right sides thereof, wherein the intake holes 15a and 15b are hollows for suctioning the air for cooling into the interior of the information processing apparatus 1 through the cooling unit 23 as illustrated in FIG. 6 (although not illustrated in FIG. 16, discharge holes are formed on the back surface of the housing of the information processing apparatus 1).

Arrows illustrated in FIG. 17 indicate the flow of the air for cooling suctioned from the intake holes 15a and 15b. As described above, a hollow structure for suction is provided to the speaker 10, thereby allowing the speaker 10 to perform an intake function.

In this way, it is possible to reduce the intake structure provided in the housing 20 (for example, a housing of a back surface side) of the information processing apparatus 1. Furthermore, the housing 20 of the information processing apparatus 1 do not have to have the intake structure. Consequently, it is possible to mount the speaker 10 with the large capacity speaker structure in the information processing apparatus 1 without disturbing a cooling function.

Furthermore, the intake holes 15a and 15b are provided on a plane level with a plane through which speaker audio is output. Consequently, the intake structure is formed in a place not easily visible by a user, so that it is possible to enhance design properties of an outlook shape of the information processing apparatus 1.

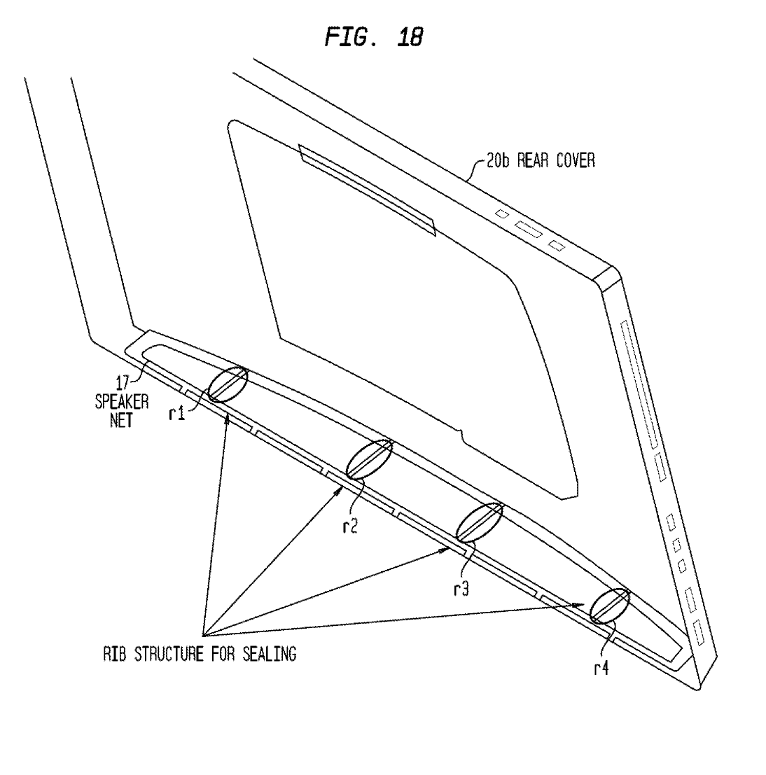

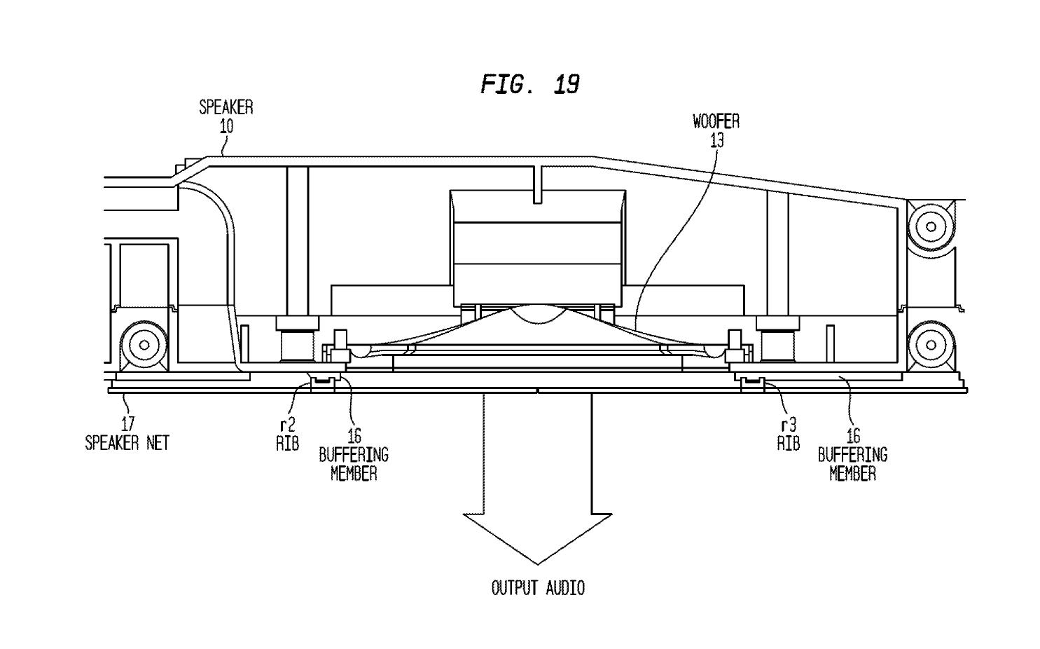

Next, a sealing structure of the speaker 10 will be described. FIG. 18 and FIG. 19 are diagrams illustrating a sealing structure of the speaker. On a bottom surface of a rear cover 20b of the information processing apparatus 1, protrusions of ribs r1 to r4 are formed and a speaker net 17 is provided. The speaker net 17 is formed with an arbitrary number of punch holes (not illustrated).

Meanwhile, the speaker 10 is provided with a buffering member 16 (for example, a sponge and the like) at a position in contact with the ribs r1 to r4 when the speaker 10 is mounted in the information processing apparatus 1.

When the speaker 10 is mounted in the information processing apparatus 1, the ribs r1 to r4 press the buffering member 16, so that the speaker 10 is sealed and partitioned in units of speaker units by the ribs r1 to r4 and the buffering member 16.

In detail, when the speaker 10 is installed at the information processing apparatus 1, the speaker 11 for a left channel is sealed and partitioned by the ribs r1 and r2 and the buffering member 16 provided to the speaker 10.

Furthermore, when the speaker 10 is installed at the information processing apparatus 1, the speaker 12 for a right channel is sealed and partitioned by the ribs r3 and r4 and the buffering member 16 provided to the speaker 10.

Moreover, when the speaker 10 is installed at the information processing apparatus 1, the woofer 13 is sealed and partitioned by the ribs r2 and r3 and the buffering member 16 provided to the speaker 10 (FIG. 19 illustrates a sealing state of the woofer 13).

In this way, the speakers are sealed and partitioned in units of speaker units, so that it is possible to prevent audios of each speaker from being leaked to the housing 20 and being diffused to the housing 20, and thus it is possible to appropriately output the speaker audio out of the housing 20.

Additionally, the present technology way may also be configured as below.

(1) An information processing apparatus including:

a speaker in a housing, the speaker being integrally formed with each speaker unit of a speaker for a left channel that outputs left channel audio, a speaker for a right channel that outputs right channel audio, and a speaker for bass that outputs bass.

(2) The information processing apparatus according to (1),

wherein the speaker for a left channel has a first bass reflex port, the speaker for a right channel has a second bass reflex port, and the speaker for bass has a third bass reflex port, and

wherein the first to third bass reflex ports are formed by being expanded to adjacent speaker units according to a predetermined length.

(3) The information processing apparatus according to (1) or (2),

wherein the speaker is provided with an intake structure for cooling an interior of the housing.

(4) The information processing apparatus according to any one of (1) to (3),

wherein a protrusion is provided on a bottom surface of the housing,

wherein the speaker is provided with a buffering member in contact with the protrusion, and

wherein when the speaker is mounted on the housing, the protrusion presses the buffering member, and each of the speaker for a left channel, the speaker for a right channel, and the speaker for bass is sealed and is partitioned for each speaker unit by the protrusion and the buffering member.

(5) The information processing apparatus according to any one of (1) to (4),

wherein the speaker for a left channel has a speaker cable for a left channel, the speaker for a right channel has a speaker cable for a right channel, the speaker for bass has a speaker cable for bass, and the speaker cable for a left channel, the speaker cable for a right channel, and the speaker cable for bass are bundled to form one outlet.

(6) A speaker including:

a speaker for a left channel that outputs left channel audio;

a speaker for a right channel that outputs right channel audio; and

a speaker for bass that outputs bass,

wherein each speaker unit of the speakers is integrally formed with the speaker.

(7) The speaker according to (6),

wherein the speaker for a left channel has a first bass reflex port, the speaker for a right channel has a second bass reflex port, the speaker for bass has a third bass reflex port, and

wherein the first to third bass reflex ports are formed by being expanded to adjacent speaker units according to a predetermined length.

(8) The speaker according to (6) or (7), further including

an intake structure for cooling an interior of a housing on which the speaker is mounted.

(9) The speaker according to any one of (6) to (8), further including

a buffering member in contact with a protrusion provided on a bottom surface of a housing on which the speaker is mounted, and

wherein at a time of mounting, the protrusion presses the buffering member, and each of the speaker for a left channel, the speaker for a right channel, and the speaker for bass is sealed and is partitioned for each speaker unit by the protrusion and the buffering member.

(10) The speaker according to any one of (6) to (9),

wherein the speaker for a left channel has a speaker cable for a left channel, the speaker for a right channel has a speaker cable for a right channel, the speaker for bass has a speaker cable for bass, and

wherein the speaker cable for a left channel, the speaker cable for a right channel, and the speaker cable for bass are bundled to form one outlet.

In addition, the aforementioned embodiment can be variously changed without departing from the scope of an embodiment.

Moreover, the aforementioned embodiment can be variously modified and changed by a person of ordinary skill in the art, and is not limited to the described exact configuration and application example.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a speaker in a housing, the speaker including speaker units of a speaker for a left channel that outputs left channel audio, a speaker for a right channel that outputs right channel audio, and a speaker for bass that outputs bass,
wherein each of the speaker units is integrally formed with one another.

2. The information processing apparatus according to claim 1,
wherein the speaker for a left channel has a first bass reflex port, the speaker for a right channel has a second bass reflex port, and the speaker for bass has a third bass reflex port, and
wherein the first to third bass reflex ports are formed by being expanded to adjacent speaker units according to a predetermined length.

3. The information processing apparatus according to claim 1,
wherein the speaker is provided with an intake structure for cooling an interior of the housing.

4. The information processing apparatus according to claim 1,
wherein a protrusion is provided on a bottom surface of the housing,
wherein the speaker is provided with a buffering member in contact with the protrusion, and
wherein when the speaker is mounted on the housing, the protrusion presses the buffering member, and each of the speaker for a left channel, the speaker for a right channel, and the speaker for bass is sealed and is partitioned for each speaker unit by the protrusion and the buffering member.

5. The information processing apparatus according to claim 1,
wherein the speaker for a left channel has a speaker cable for a left channel, the speaker for a right channel has a speaker cable for a right channel, the speaker for bass has a speaker cable for bass, and the speaker cable for a left channel, the speaker cable for a right channel, and the speaker cable for bass are bundled to form one outlet.

6. A speaker comprising:
a speaker for a left channel that outputs left channel audio;
a speaker for a right channel that outputs right channel audio; and
a speaker for bass that outputs bass,
wherein each speaker unit is integrally formed with one another.

7. The speaker according to claim 6,
wherein the speaker for a left channel has a first bass reflex port, the speaker for a right channel has a second bass reflex port, the speaker for bass has a third bass reflex port, and
wherein the first to third bass reflex ports are formed by being expanded to adjacent speaker units according to a predetermined length.

8. The speaker according to claim 6, further comprising an intake structure for cooling an interior of a housing on which the speaker is mounted.

9. The speaker according to claim 6, further comprising:
a buffering member in contact with a protrusion provided on a bottom surface of a housing on which the speaker is mounted,
wherein at a time of mounting, the protrusion presses the buffering member, and each of the speaker for a left channel, the speaker for a right channel, and the speaker for bass is sealed and is partitioned for each speaker unit by the protrusion and the buffering member.

10. The speaker according to claim 6,
wherein the speaker for a left channel has a speaker cable for a left channel, the speaker for a right channel has a speaker cable for a right channel, the speaker for bass has a speaker cable for bass, and
wherein the speaker cable for a left channel, the speaker cable for a right channel, and the speaker cable for bass are bundled to form one outlet.
